(19) United States
(12) Patent Application Publication
(10) Pub. No.: US 2021/0372497 A1
(43) Pub. Date: Dec. 2, 2021

(54) LEAF SPRING FOR BOTTLE GRIPPING ASSEMBLY

(71) Applicant: AMTIG ENGINEERING SOLUTIONS, LLC, Coldwater, MI (US)

(72) Inventor: Steven GROHOLSKI, Coldwater, MI (US)

(21) Appl. No.: 16/890,453

(22) Filed: Jun. 2, 2020

(51) Int. Cl. F16F 1/18; B65G 47/86; B67C 3/24

(52) U.S. Cl. CPC F16F 1/185; B65G 2201/0244; B67C 3/242; B65G 47/842

(57) ABSTRACT

A bottle gripping assembly comprising a pair of bottle gripping arms, each of the bottle gripping arms having a grip member such that when the grip members of the bottle gripping arms are moved toward each other, the pair of bottle gripping arms can grip a bottle therebetween. The bottle gripping assembly also includes a base for supporting the pair of bottle gripping arms, the base including an opening adjacent the pair of bottle gripping arms. The opening is configured to accept an actuator therethrough for actuating the bottle gripping arms to move the grip members of the bottle gripping arms toward each other. Each of the bottle gripping arms includes a leaf spring made of PEEK adapted to abut the actuator.

### FIELD OF THE INVENTION

The present invention relates to bottling, and in particular to an improved leaf spring for a bottle gripping assembly.

### BACKGROUND OF THE INVENTION

Conveyor systems have been developed for quickly filling and capping a multitude of bottles in a very short period of time. The conveyor systems move empty and uncapped bottles along a line and/or along a periphery of a wheel and fill the bottles (with, for example, water, soda or any other liquid) and cap the bottles while the bottles continuously move.

FIGS. 1A and 1B illustrate a prior art bottle gripping assembly 10. The prior art bottle gripping assembly 10 includes a pair of grip arms 12 that grip the bottle (not shown) as the bottle is moved about the periphery of a wheel. The prior art bottle gripping assembly 10 includes a base plate 14 for holding the grip arms 12. The base plate 14 can be a part of the wheel of the conveyor system or can be connected to the wheel. The base plate 14 includes a rear wide portion 16 having a central actuator opening 18. The rear wide portion 16 of the base plate 14 is also shown as including a plurality of fastener opening 20 for accepting fasteners therethrough for connecting the base plate 14 to the wheel of the conveyor system. The base plate 14 also includes a front narrow support portion 22 with a pair of bolt openings (not shown).

The grip arms 12 of the prior art bottle gripping assembly 10 are actuated to selectively grip and hold the bottles. The grip arms 12 are mirror images of each other such that only one grip arm 12 will be discussed, with the understanding that the other grip arm 12 has the same features in reverse. The grip arm 12 includes a main section 24 that tapers toward the rear of the grip arm 12. The main section 24 includes an inwardly facing C-shaped rear recess 26 having a pair of end fingers 28 that extend toward each other and that each define a spring receiving slot 30. A vertically oriented leaf spring 32 is located within the inwardly facing C-shaped rear recess 26, with ends of the vertically oriented leaf spring 32 being located within the spring receiving slots 30. A middle area of the main section 24 includes a bolt hole (not shown). A front area of the main section 24 includes an inwardly facing spring recess 34. As illustrated in FIG. 1A, a spring 36 extends between the inwardly facing spring recesses 34 of the grip arms 12, with ends of the spring 36 being located within facing spring receiving bores (not shown). The grip arm 12 also includes a front curved grip member 38 having an arcuate inner face 40. A plurality of support lips 42 extending inwardly from the arcuate inner face 40.

A top holder bracket 44 and a pair of bolts 52 connect the grip arms 12 to the base plate 14. The top holder bracket 44 is substantially rectangular and includes a T-shaped opening 46 as viewed from the top (FIG. 1A). A rear portion of the top holder bracket 44 outside of the T-shaped opening 46 defines a support bar 48. Front panels 50 on either side of the base of the T-shaped opening 46 have bolt holes (not shown). The bolts 52 have heads 54 that rest on the top of the front panels 50. Threaded post portions 58 of the bolts 52 extend through the bolt holes in the front panels 50 of the top holder bracket 44, through the bolt holes in the middle area of the main section 24 of the grip arms 12 and into the bolt openings (which are internally threaded) in the front narrow support portion 22 of the base plate 14.

FIG. 1A illustrates the prior art bottle gripping assembly 10 in a bottle receiving position. As illustrated in FIG. 1A, a flat actuator 56 extends through the actuator opening 18 rear wide portion 16 of the base plate 14 and is located between the leaf springs 32 of the grip arms 12. When the flat actuator 56 does not abut the leaf springs 32 (as shown), the spring 36 forces the front curved grip members 38 of the grip arms 12 away from each other about the threaded post portions 58 of the bolts 52. However, when an upper portion of the bottle is inserted into the area 60 between the front curved grip members 38 of the grip arms 12, the flat actuator 56 is rotated by 90° to press against the leaf springs 32, thereby forcing the rear area of main section 24 of the grip arms 12 away from each other about the threaded post portions 58 of the bolts 52, such that the front curved grip members 38 of the grip arms 12 move toward each other and capture the top portion of the bottle within the area 60 between the front curved grip members 38 of the grip arms 12 and the support lips 42 being located below a ring of the bottle.

FIG. 2B illustrates prior art bottle gripping assembly 10 (open), 10′ (closed) on a wheel 114 of the conveyor system as is well known to those skilled in the art. As shown in FIG. 2B, a plurality of fasteners 116 extend through the fastener openings 20 of the base plate 14 to connect each of the prior art bottle gripping assembly 10 to the wheel 114.

During use of the prior art bottle gripping assembly 10, the actuator 56 can be actuated to move the grip arms 12 to grip a bottle 500 as outlined above, with the support lips 42 of the grip arms 12 supporting a top ring 502 of the bottle 500 located below a threaded cylinder 504 of the bottle 500 as shown in FIG. 2A. As shown in FIG. 2B, when the prior art bottle gripping assembly 10 is in an open position, the flat actuator 56 does not engage the vertically oriented leaf spring 32. In the open position, the prior art bottle gripping assembly 10 does not hold the bottle 500 as shown in FIG. 2A. However, when the flat actuator 56 rotates against the vertically oriented leaf spring 32 of the prior art bottle gripping assembly 10′ as shown in FIG. 2B, the prior art bottle gripping assembly 10′ moves to the closed position to hold the bottle 500 as shown in FIG. 2A.

For over 30 years, the prior art bottle gripping assembly 10 employed a vertically oriented leaf spring 32 made of metal and a flat actuator 56 made of metal. The metal of the flat actuator 56 and the metal of the vertically oriented leaf spring 32 would rub against each other for every actuation of the flat actuator 56, creating metal dust over time and needed to be replaced after substantial wear. The metal dust needs to be periodically cleaned from the entire factory, which can be very expensive. Moreover, the metal on metal contact causes the vertically oriented leaf spring 32 to wear such that the vertically oriented leaf spring 32 needs to be replaced often. Replacing any part of the prior art bottle gripping assemblies 10 requires that the bottling process be stopped, which can be quite costly.

### SUMMARY OF THE INVENTION

The present invention, according to one aspect, is directed to a bottle gripping assembly comprising a pair of bottle gripping arms, each of the bottle gripping arms having a grip member such that when the grip members of the bottle gripping arms are moved toward each other, the pair of bottle gripping arms can grip a bottle therebetween. The bottle gripping assembly also includes a base for supporting the pair of bottle gripping arms, the base including an opening adjacent the pair of bottle gripping arms. The opening is configured to accept an actuator therethrough for actuating the bottle gripping arms to move the grip members of the bottle gripping arms toward each other. Each of the bottle gripping arms includes a leaf spring made of PEEK adapted to abut the actuator.

Another aspect of the present invention is to provide a bottle gripping assembly comprising a bottle gripping arm, with the bottle gripping arm having a grip member for gripping a bottle. The bottle gripping arm including an inwardly facing C-shaped rear recess having end fingers defining a pair of opposite the spring receiving slots. The bottle gripping assembly further includes a leaf spring made of PEEK, wherein opposite ends of the leaf spring made of PEEK are located within the spring receiving slots.

In yet another aspect of the present invention, a method of retrofitting a bottle gripping assembly is provided. The method includes providing a pair of bottle gripping arms, with each of the bottle gripping arms having a grip member such that when the grip members of the bottle gripping arms are moved toward each other. The pair of bottle gripping arms can grip a bottle therebetween. Each of the bottle gripping arms including a metal leaf spring adapted to abut the actuator. The method also includes providing a base for supporting the pair of bottle gripping arms. The base includes an opening adjacent the pair of bottle gripping arms. The opening is configured to accept an actuator therethrough for actuating the bottle gripping arms to move the grip members of the bottle gripping arms toward each other. The method further includes removing the metal leaf spring from each of the bottle gripping arms and inserting a leaf spring made of PEEK in a position formerly occupied by the metal leaf spring.

### BRIEF DESCRIPTION OF THE DRAWINGS

One or more embodiments of the present invention are illustrated by way of example and should not be construed as being limited to the specific embodiments depicted in the accompanying drawings, in which like reference numerals indicate similar elements.

FIG. 1A is a top view of a prior art bottle gripping assembly.

FIG. 1B is a side view of the prior art bottle gripping assembly.

FIG. 2A is a side view of a prior art bottle gripping assembly holding a bottle.

FIG. 2B is a top view of multiple prior art bottle gripping assemblies on a filling wheel.

FIG. 3 is a top view of a grip arm of a bottle gripping assembly including a leaf spring of the present invention.

FIG. 4A is a perspective view of the leaf spring of the present invention.

FIG. 4B is a top view of the leaf spring of the present invention.

FIG. 4C is a side view of the leaf spring of the present invention.

The specific devices and processes illustrated in the attached drawings and described in the following specification are simply exemplary embodiments of the inventive concepts. Hence, specific dimensions and other physical characteristics relating to the embodiments disclosed herein are not to be considered as limiting.

### DETAILED DESCRIPTION

For purposes of description herein, it is to be understood that the invention may assume various alternative orientations, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

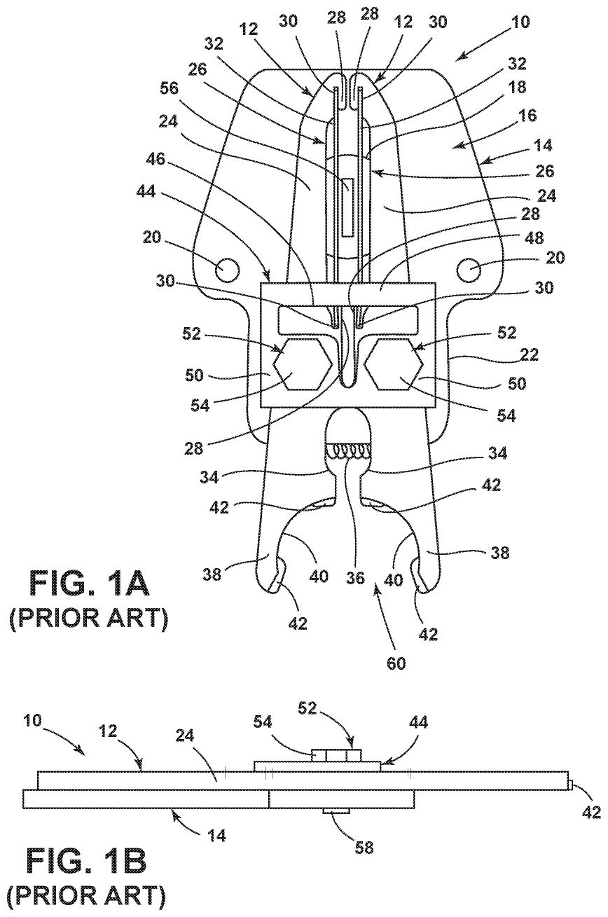

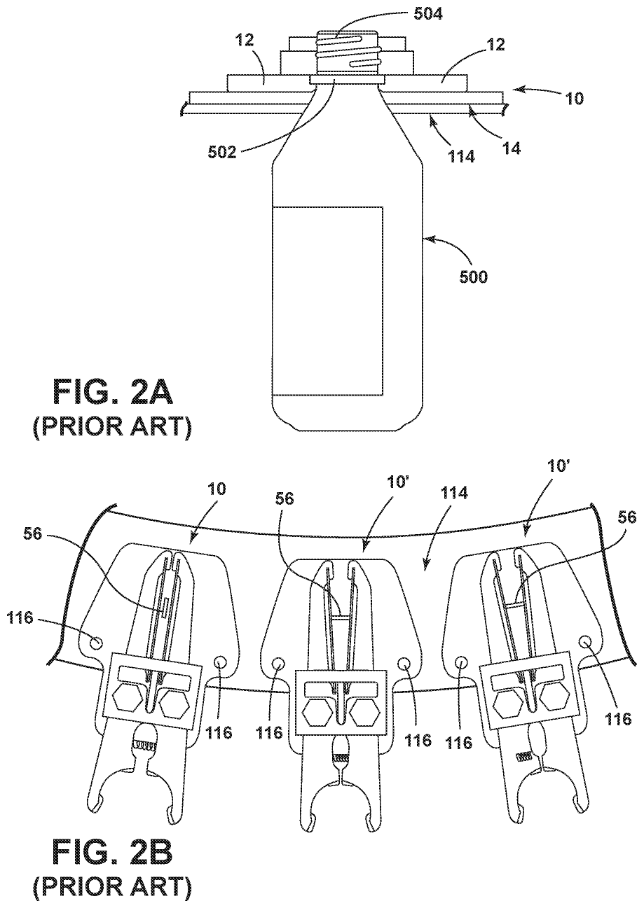

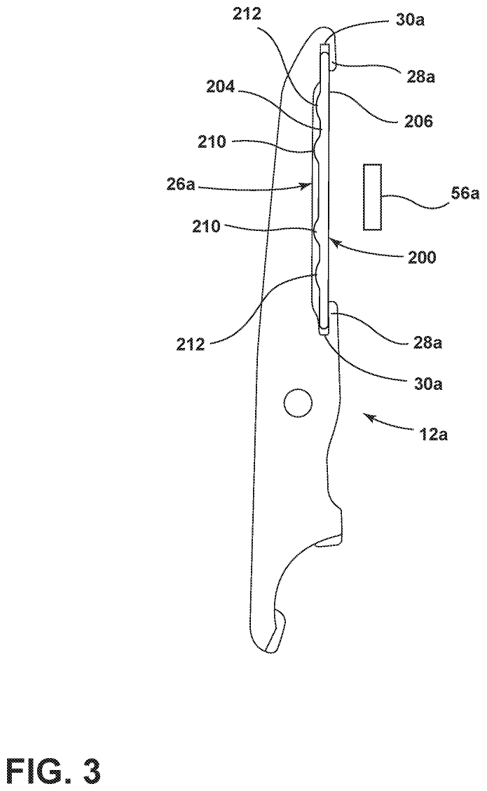

The reference number 12a (FIG. 3) generally designates a grip arm of the present invention. The grip arm 12a can be substituted for the grip arm 12 used in the bottle gripping assembly 10 of the prior art as illustrated in FIGS. 1A-2B or any other similar bottle gripping assembly. For example, the grip arm 12a can also replace the grip arm of the inventive bottle gripping assembly as disclosed in U.S. patent application Ser. No. 16/743,312 entitle BOTTLE GRIPPING ASSEMBLY, the entire contents of which are hereby incorporated herein by reference. As illustrated in FIG. 3, the grip arm 12a of the present invention includes a new leaf spring 200 substituted for the vertically oriented leaf spring 32 of the prior art grip arm 12. As illustrated in FIG. 3, the leaf spring 200 of the present invention is located in inwardly facing C-shaped rear recess 26a and in particular within the spring receiving slots 30a defined by the end fingers 28a of the inwardly facing C-shaped rear recess 26a.

The illustrated leaf spring 200 of the present invention is made of polyether ether ketone (PEEK) and provides many advantages over the prior art leaf spring 32. PEEK was developed approximately 35-40 years ago and has never been used as the material of a leaf spring for a grip arm of a bottle gripping assembly. The leaf spring 200 of the present invention made of PEEK has a longer life span than the prior art leaf spring 32 and also does not dust or metal dust over time. Since no metal dust is created by the leaf spring 200 of the present invention made of PEEK, a factory employing the leaf spring 200 of the present invention made of PEEK does not need to be cleaned. Moreover, the leaf spring 200 of the present invention made of PEEK lasts longer than the prior art leaf spring 32 such that the leaf spring 200 of the present invention made of PEEK does not have to be replaced as often, thereby increasing the yearly output of a factory filling bottles and saving the factory potentially millions of dollars each year. While PEEK has been around for approximately 35-40 and the metal leaf spring 32 has been in use for over 30 years, no one has realized the millions of dollars in savings by using the leaf spring 200 of the present invention made of PEEK until the realization of the present inventor.

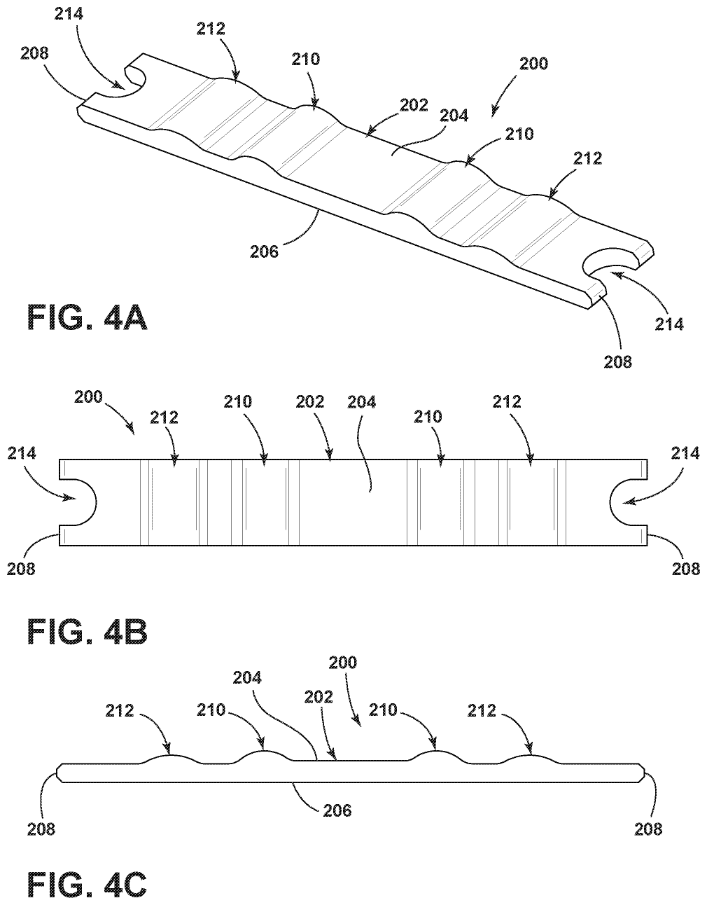

In the illustrated example, the leaf spring 200 of the present invention made of PEEK has generally the same dimensions of the prior art leaf spring 32. Therefore, the leaf spring 200 of the present invention made of PEEK includes a substantially flat body 202 having a top surface 204 and a bottom surface 206. Opposite end edges 208 of the flat body 202 of leaf spring 200 of the present invention made of PEEK includes recesses 214. The leaf spring 200 of the present invention made of PEEK can includes a pair of inner curved protrusions 210 and a pair of outer curved protrusions 212 extending from the top surface 204 of the flat body 202. As illustrated in FIGS. 4A-4C, the pair of inner curved protrusions 210 are taller than the pair of outer curved protrusions 212.

As illustrated in FIG. 3, the top surface 204 of the flat body 202 of the leaf spring 200 of the present invention made of PEEK faces the wall of the inwardly facing C-shaped rear recess 26a of the grip arm 12a. During sue of the grip arm 12a, the actuator 56s presses against the bottom surface 206 of the flat body 202 of the leaf spring 200 of the present invention made of PEEK to move the grip arms 12a. The pair of inner curved protrusions 210 and the pair of outer curved protrusions 212 extending from the top surface 204 of the flat body 202 limit flexing of the leaf spring 200 of the present invention made of PEEK when the tops thereof will abut the wall of the inwardly facing C-shaped rear recess 26a of the grip arm 12a.

Although particular preferred embodiments of the invention have been disclosed in detail for illustrative purposes, it will be recognized that variations or modifications of the disclosed apparatus, including the rearrangement of parts, lie within the scope of the present invention.

What is claimed is:

1. A bottle gripping assembly comprising:
a pair of bottle gripping arms, each of the pair of bottle gripping arms having a grip member such that when the grip members of the pair of bottle gripping arms are moved toward each other, the pair of bottle gripping arms can grip a bottle therebetween;
a base for supporting the pair of bottle gripping arms, the base including an opening adjacent the pair of bottle gripping arms, the opening being configured to accept an actuator therethrough for actuating the pair of bottle gripping arms to move the grip members of the pair of bottle gripping arms toward each other; and
each of the pair of bottle gripping arms including a leaf spring made of PEEK adapted to abut the actuator.

2. The bottle gripping assembly of claim 1, further including:
a spring extending between the pair of bottle gripping arms, the spring biasing the grip members of the pair of bottle gripping arms away from each other.

3. The bottle gripping assembly of claim 1, wherein:
each of the pair of bottle gripping arms includes an inwardly facing C-shaped rear recess having end fingers defining a pair of opposite spring receiving slots; and
opposite ends of the leaf spring made of PEEK are located within the spring receiving slots.

4. The bottle gripping assembly of claim 3, wherein:
each leaf spring made of PEEK includes a substantially flat body having a top surface and a bottom surface, with the top surface including a pair of inner curved protrusions and a pair of outer curved protrusions extending from the top surface of the substantially flat body.

5. The bottle gripping assembly of claim 4, wherein:
the pair of inner curved protrusions are taller than the pair of outer curved protrusions.

6. The bottle gripping assembly of claim 1, wherein:
each leaf spring made of PEEK includes a substantially flat body having a top surface and a bottom surface, with the top surface including a pair of inner curved protrusions and a pair of outer curved protrusions extending from the top surface of the substantially flat body.

7. The bottle gripping assembly of claim 6, wherein:
the pair of inner curved protrusions are taller than the pair of outer curved protrusions.

8. A bottle gripping assembly comprising:
a bottle gripping arm, the bottle gripping arm having a grip member for gripping a bottle;
the bottle gripping arm including an inwardly facing C-shaped rear recess having end fingers defining a pair of opposite spring receiving slots; and
a leaf spring made of PEEK;
opposite ends of the leaf spring made of PEEK are located within the spring receiving slots.

9. The bottle gripping assembly of claim 8, wherein:
each leaf spring made of PEEK includes a substantially flat body having a top surface and a bottom surface, with the top surface including a pair of inner curved protrusions and a pair of outer curved protrusions extending from the top surface of the substantially flat body.

10. The bottle gripping assembly of claim 9, wherein:
the pair of inner curved protrusions are taller than the pair of outer curved protrusions.

11. A method of retrofitting a bottle gripping assembly comprising:
providing a pair of bottle gripping arms, each of the bottle gripping arms having a grip member such that when the grip members of the bottle gripping arms are moved toward each other, the pair of bottle gripping arms can grip a bottle therebetween, each of the bottle gripping arms including a metal leaf spring adapted to abut an actuator;
providing a base for supporting the pair of bottle gripping arms, the base including an opening adjacent the pair of bottle gripping arms, the opening being configured to accept the actuator therethrough for actuating the bottle gripping arms to move the grip members of the bottle gripping arms toward each other;
removing the metal leaf spring from each of the bottle gripping arms; and
inserting a leaf spring made of PEEK in a position formerly occupied by the metal leaf spring.

12. The method of claim 11, wherein:
a spring extends between the pair of bottle gripping arms, the spring biasing the grip members of the pair of bottle gripping arms away from each other.

13. The method of claim 11, wherein:
each of the bottle gripping arms includes an inwardly facing C-shaped rear recess having end fingers defining a pair of opposite the spring receiving slots; and
after the step of inserting, opposite ends of the leaf spring made of PEEK are located within the spring receiving slots.

14. The bottle gripping assembly of claim 13, wherein:
each leaf spring made of PEEK includes a substantially flat body having a top surface and a bottom surface, with the top surface including a pair of inner curved protrusions and a pair of outer curved protrusions extending from the top surface of the substantially flat body.

15. The bottle gripping assembly of claim 14, wherein:
the pair of inner curved protrusions are taller than the pair of outer curved protrusions.

16. The bottle gripping assembly of claim 11, wherein:
each leaf spring made of PEEK includes a substantially flat body having a top surface and a bottom surface, with the top surface including a pair of inner curved protrusions and a pair of outer curved protrusions extending from the top surface of the substantially flat body.

17. The bottle gripping assembly of claim 16, wherein:
the pair of inner curved protrusions are taller than the pair of outer curved protrusions.
